(19) United States
(12) Patent Application Publication
(10) Pub. No.: US 2013/0272656 A1
(43) Pub. Date: Oct. 17, 2013

(54) Double-Sided Compression-Tuned Fiber Bragg Grating

(71) Applicants: Mohammad Abtahi, Montreal (CA); Pin Long, Montreal (CA)

(72) Inventors: Mohammad Abtahi, Montreal (CA); Pin Long, Montreal (CA)

(73) Assignee: O/E LAND Inc., Quebec (CA)

(21) Appl. No.: 13/444,573

(22) Filed: Apr. 11, 2012

(51) Int. Cl. G02B 6/34

(52) U.S. Cl. 385/37

(57) ABSTRACT

A new type of tunable fiber Bragg grating (FBG) is proposed based on the compression of FBG from both sides. In this technique, the FBG is compressed from both sides simultaneously which provides the more uniform force distribution along the grating compared to the compression from one side. As a result, the grating period changes uniformly due to compression and the same spectral shape can be achieved over a wide spectrum. The double-sided compression technique represents a significant improvement over the prior wavelength tunable fiber grating techniques, especially for the long gratings.

### BACKGROUND OF INVENTION

The tunable FBG filters are the key components in many applications including optical communications as the tunable DWDM add-drop multiplexers, channel monitoring, tunable fiber lasers, optical fiber sensors, and so on.

The central wavelength of a fiber Bragg grating can be tuned by modifying the fiber refraction index or by changing the grating period. These variations can be induced thermally [1] or by mechanical stresses [2]. Due to the good silica behavior under stress, the mechanical compression or strain is normally preferred over thermal tuning. In particular, compression could provide more tuning span compared to the stretching which is limited by the tensile strength of the fiber.

Various approaches are proposed to compress the fiber [2-5]. For instance, a flexible beam is used in [3] to make the curvature in the fiber which could be controlled manually or by a motorized actuator. Axial compression of the fiber Bragg grating as described in U.S. Pat. No. 5,469,520 [2] and analyzed in [4-5] is another technique that received much attention. In this technique, the FBG is confined in a ferrule to prevent from bending during the compression. The fiber is fixed on one end to the stage while the other end is fixed on a movable stage which controls manually or by a motorized actuator. While the concept of the axial compression is the same, different approaches are focused on the choose of system parameters like grating and ferrule sizes, the gap between ferrules, maximum strain, etc to make a uniform strain over the FBG length and to prevent the fiber from local or global buckling. A fiber buckling creates non uniformities in the fiber strain which causes a non uniform variation in the grating period. As a result, the shape of grating filter is no longer the same; the higher the strain, the wider the bandwidth.

In all aforementioned approaches, the FBG is fixed from one end on a fixed stage and from other end on a movable stage. The unguided fiber length is at least equal to the maximum axial displacement. On the other hand, the maximal allowable length without bending of an unguided fiber is limited by a critical length based on the buckling theory of columns [4]. The critical length is a function of the stressed length and the axial displacement and in some cases, especially for long gratings limits the maximum shift in the central wavelength.

In this invention, we present a novel technique to compress or strain the FBG from both sides in order to get the more uniform force distribution along the grating and also the smaller unguided fiber length. As the axial displacement can be assumed to be on the both sides of the grating, the unguided fiber length is divided by a factor of two, which could double the maximum possible shift in the Bragg central wavelength. The first above-mentioned factor results a wider shift without changing the spectral shape of the filter compared to the conventional techniques.

### OBJECTS OF THE INVENTION

An object of the present invention is to provide a novel technique to compress or strain the FBG from both sides.

Another object of the present invention is to compress the long gratings uniformly over the wide spectrum.

Another object of the present invention is to increase the shift in the FBG central wavelength without changing the spectral shape of FBG.

Still another object of the present invention is to more uniformly distribute the strain along the grating.

Still another object of the present invention is to change the grating period uniformly.

Still another object of the present invention is to reduce the unguided fiber length.

Still another object of the present invention is to prevent the fiber bending in the unguided fiber section.

Still another object of the present invention is to increase the maximum supportable strain by the FBG in the unguided section before breakage.

### SUMMARY OF THE INVENTION

According to the present invention, a fiber grating is compressed from the both sides simultaneously or individually. The present innovation represents a significant improvement over the prior wavelength tunable fiber grating techniques by dividing the axial displacement length in two sections at both ends of the fiber grating. In some applications, the tunable fiber grating filters with a narrow bandwidth (less than 0.1 nm) and high extinction ratio (>30 dB) is needed. To meet these requirements, the grating length could be up to 20 mm or even longer. The compression of such a long grating over a wide spectrum needs a large axial displacement which could be larger than the maximal allowable length without bending of an unguided fiber. According to the present innovation, the long fiber gratings can be compressed uniformly and at least the same central wavelength shift as for the short gratings can be obtained without remarkable changes in the bandwidth or the spectral filter shape.

### BRIEF DESCRIPTION OF THE DRAWINGS

For a better understanding of the present invention, reference is made to the following detailed description and the attached figures, where:

FIG. 1 is a side view of the fixed and moving ferrules having a fiber with FBG therein, in accordance with the present innovation.

FIG. 2 compares the compression of grating inside ferrule from one side to the compression from both sides, in accordance with the present innovation.

FIG. 3 is a side view of a compress device for compressing a fiber grating form both sides simultaneously, in accordance with the present innovation.

FIG. 4 is a side view of a compress device for compressing a fiber grating form both sides individually, in accordance with the present innovation

FIG. 5 shows the manual rotation of shafts, in accordance with the present innovation.

FIG. 6 shows the motorized rotation of shafts, in accordance with the present innovation.

### DETAILED DESCRIPTION OF THE PREFERRED EMBODIMENTS

With reference to the annexed drawings the preferred embodiment of the present invention will be herein described for indicative purpose and by no means as of limitation.

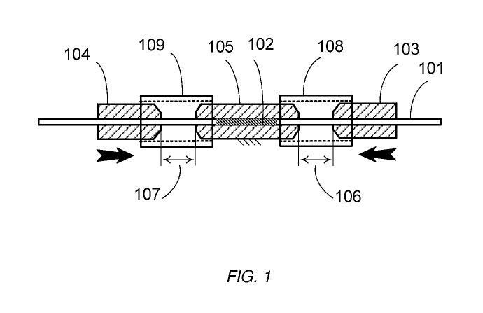

Referring to FIG. 1, there is shown an embodiment of an optical fiber 101 with the fiber grating 102, passing through the fixed ferrule 105 and two sliding ferrules 103, 104. The metallic or ceramic ferrules could be used. The fiber is fixed inside the ferrules 103 and 104 by using the adhesive glue. The length of ferrule 105 is at least equal to the length of grating 102. The internal diameter of ferrule should be few micro-meters more than the fiber cladding diameter. For a regular single-mode fiber (SMF-28), the cladding diameter is 125 microns and a ferrule internal diameter of 126 to 135 microns should be used. The larger ferrule diameters could be used, but the fiber will be bending more inside the ferrule during the compression.

The gap 106 between the fixed ferrule 105 and moving ferrules 103 contains the unguided fiber and permits to compress the grating when the ferrule 103 moves toward ferrule 105. The gap 107 between the fixed ferrule 105 and moving ferrules 104 contains the unguided fiber and permits to compress the grating when the ferrule 104 moves toward ferrule 105. The ceramic tubes 108 and 109 with a length of 10 mm are used to cover and protect the unguided fibers and also to align the ferrules during the displacement. When ferrule 104 moves toward ferrule 105, the ceramic tube 109 keeps them well aligned all the time.

The gaps 106 and 107 could be the same or different. If the ferrules 103 and 104 move simultaneously as it will be explained later in the present innovation, the gaps sizes should be the same. The total gap length of 106 and 107 determines the maximum axial displacement in the fiber, ΔL. It is related to the total shift in the central wavelength, Δλ by: Δλ/λ=α ΔL/L, where λ is the FBG center wavelength and L is the fiber length before strain. α is a parameter related to photoelastic coefficient of the fiber and is about 0.79 [4]. By having the fiber length, center wavelength and the shift in the center wavelength, the fiber axial displacement length can be calculated from the above equation. The gap length 106 and 107 are simply half of the fiber displacement length.

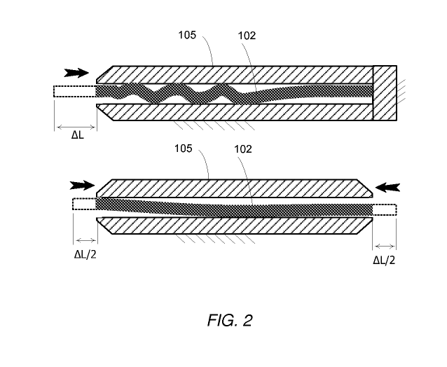

For the long gratings, the fiber axial displacement length could be in the order or longer than the maximal allowable length without bending of an unguided fiber and the compress technique as described in U.S. Pat. No. 5,469,520 is not able to provide a big shift in the center wavelength without changing the spectral shape due to fiber buckling and the fiber breakage. FIG. 2 compares the compression of the grating from one side to the compression from both sides. When the long axial displacement ΔL is applied from one side, the force cannot be distributed uniformly through the grating 102. The grating bends inside the ferrule 105 and the period of grating changes non-uniformly resulting a wider spectrum. However, in the present innovation, the axial displacement in each side is half of the total axial displacement which provides much better force distribution along the grating as illustrated in FIG. 2. Using the present technique, a longer shift in the center wavelength without changing the spectral shape can be obtained compared to the technique described in U.S. Pat. No. 5,469,520, assuming all other parameters are the same.

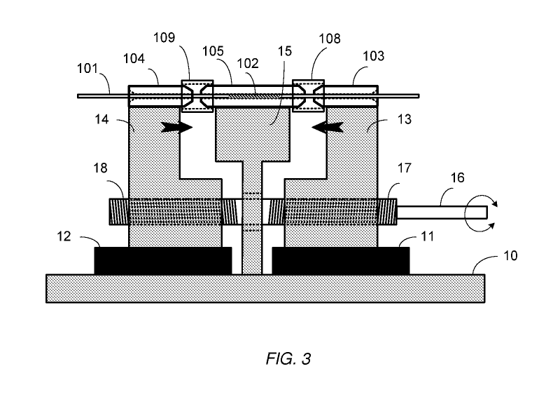

Referring now to FIG. 3, one embodiment of the fiber compressing device comprises a base 10 having a length of about 12 cm which supports two sliding stages 11, 12 having a length of 4 cm each. Support 13 and 14 are fixed on the sliding stages 11, 12, respectively. A rotating shaft 16 connects to a screw bar with left-handed thread 17 on the first half and the right-handed thread 18 on the other side. Support 13 has a 45 deg. V-groove on the top to keep the ferrule 103 and a hole with the left-handed threads to accept the left-handed screw bar 17. Support 14 has a 45 deg. V-groove on the top to keep the ferrule 104 and a hole with the right-handed threads to accept the right-handed screw bar 18. The support 15 has a 45 deg. V-groove on the top to keep the ferrule 105. The rotating screw bar 17 (18) passes through a hole in support 15 with a diameter larger than the bar diameter to prevent any touch between the bar and support 15. The fiber embodiment in FIG. 1 is installed on the top of supports 13, 14, 15. The ferrules 103, 104 and 102 are fixed using glue in the V-grooves on the top of supports 13, 14 and 15, respectively.

By rotating the shaft 16 clockwise, the support 13 moves to the left and at the same time, the support 14 moves to the right compressing the FBG from both sides. The shaft 16 could be rotated manually or by using a motorized actuator. By rotating the shaft 16 counter-clockwise, the support 13 moves to the right and at the same time, the support 14 moves to the left relaxing the grating from both sides.

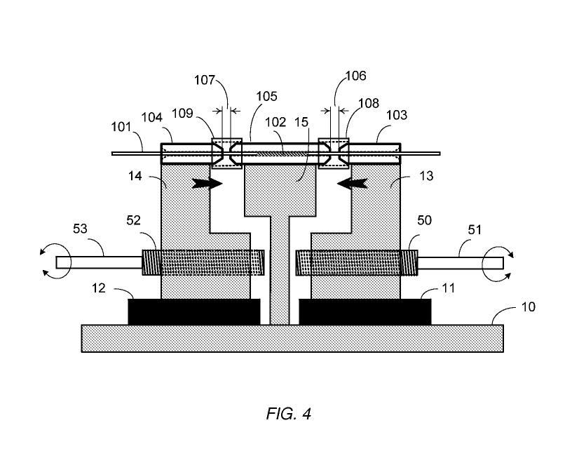

Referring now to FIG. 4 in which the screw bars 17 and 18 in FIG. 3 are replaced with the screw bars 50 and 52 in order to move the supports 13 and 14 individually. 50 is a right-handed thread screw bar connected to shaft 51. 52 is also a right-handed thread screw bar connected to shaft 53. The shaft 51 and 53 can be rotated by the micro-controllers manually or by motorized actuators. The micro-controllers or the motorized actuators can also be directly connected to the sliding stages 11 and 12. The embodiment in FIG. 4 compresses the grating from both sides individually. The gap 106 and 107 in FIG. 4 could be the same or different.

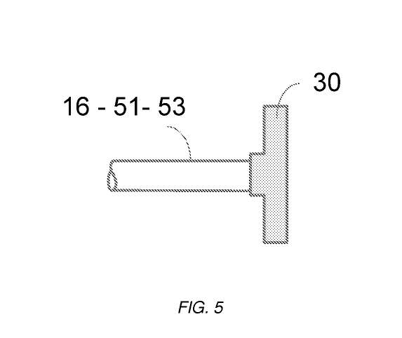

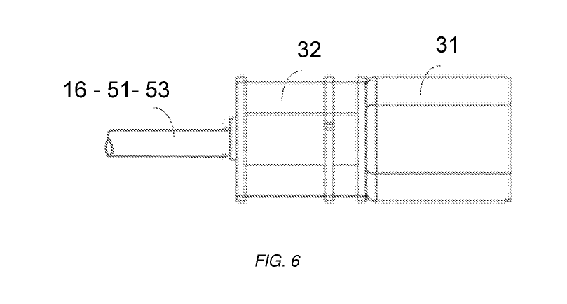

The manual rotation of shafts is shown in FIG. 5, where the shaft 16 in FIG. 3 or the shaft 51 or 53 in FIG. 4 is connected to the knob 30 for easy rotation. The motorized rotation is depicted in FIG. 6. The shaft 16 in FIG. 3 or the shaft 51 or 53 in FIG. 4 is connected to the motorized actuator 31 through the gear box 32. The gear box 32 increases the rotational resolution. For example, a 100:1 gear box can be used. Other ratio gear box may be used to provide the required resolution if desired.

### REFERENCE

[1] L. Eldada, et al., “Thermo-optic Planar Polymer Bragg Grating OADM's with Broad Tuning Range,” Photonics Tech. Let., vol. 11, no. 4, April 1999.

[2] Morey et al., “Compression-Tuned Fiber Grating,” U.S. Pat. No.: 5,469,520, Nov. 21, 1995.

[3] M. R. Mokhtar, et al., “Fiber Bragg grating compression-tuned over 110 nm,” Electron. Lett. Vol.39, 509, 2003.

[4] A. locco, et al., “Bragg Grating Fast Tunable Filter for Wavelength Division Multiplexing,” J. Lightwave Technol., vol. 17, no. 7, pp. 1217-1221, July 1999.

[5] N. Mohammad, et al., “Analysis and Development of a Tunable Fiber Bragg Grating Filter based on Axial Tension/Compression,” J. Lightwave Technol., vol. 22, no. 8, pp. 2001-2013, Aug. 2004.

We claim:

1. A double-sided compression-tuned fiber grating, comprising a fiber Bragg grating free to move inside a fixed metallic or ceramic ferrule and a compression mechanism in which said fiber grating is compressed from the both sides using two sliding ferrules.

2. A device as defined in claim 1, where said fiber grating is compressed from both sides simultaneously.

3. A device as defined in claim 1, where said fiber grating is compressed from both sides individually.

4. A device as defined in claim 1, where said fiber grating is used in the transmission mode.

5. A device as defined in claim 1, where said fiber grating is used in the reflection mode.

6. A device as defined in claim 1, where said fiber grating is compressed from both sides manually.

7. A device as defined in claim 1, where said fiber grating is compressed from both sides using a motorized actuator like a stepper motor or a servo motor.

8. A method for tuning the center wavelength of said fiber grating in claim 1 by compressing from both sides in order to:
a. get uniform strain distribution over the length of said fiber grating
b. change the grating period of said fiber grating uniformly
c. increase the shift in said fiber grating central wavelength without changing the spectral shape
d. compress the long fiber gratings uniformly over the wide spectrum range
e. reduce the unguided length of said fiber grating
f. prevent fiber bending in said unguided section of said fiber grating
